(19) United States
(12) Patent Application Publication
(10) Pub. No.: US 2013/0075489 A1
(43) Pub. Date: Mar. 28, 2013

(54) Pneumatic spray gun with digital pressure readout

(71) Applicant: Shiqi Zhu, Ashland, VA (US)

(72) Inventor: Shiqi Zhu, Ashland, VA (US)

(21) Appl. No.: 13/200,593

(22) Filed: Sep. 27, 2011

(51) Int. Cl. B05B 9/01

(52) U.S. Cl. 239/71

(57) ABSTRACT

An improved paint spray gun, including high volume and low pressure air paint spray guns, siphon-type paint spray guns, and gravity-fed-type spray guns, having a built-in gas pressure gauge.

### RELATED APPLICATIONS

There are no related applications.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

None.

### FIELD OF THE INVENTION

The invention relates to improved paint spray guns, including spray guns using low pressure and high volume air for atomizing the paint. The apparatus includes a built-in gas pressure gauge and adjustable controls for modulating the spray characteristics of the paint, stain or similar liquid being ejected therefrom.

### BACKGROUND OF THE INVENTION

Spray guns, especially those used with spray painting apparatuses, atomize the liquid paint by means of compressed air, generally provided via an air compressor, which enters a nozzle area via a chamber surrounding a fluid nozzle. This atomizing air is then impinged at the end of the chamber and exits via a central aperture located at the end of the chamber. Utilizing the physical phenomenon of the Venturi effect, paint is drawn from a reservoir and atomized by the pressure gradient created by the pressurized air as it exits the spray gun nozzle via the aperture.

Numerous factors affect the volume of liquid being ejected from conventional spray gun nozzles and the pattern at which it sprays, including the viscosity of the liquid, the cubic feet per minute (c.f.m.) of air being supplied by the compressor, the pressure at which that air is being regulated, regulation of the air by control valves in the spray gun itself, the length and diameter of the air hose connecting the compressor and spray gun, and modulation of the spray gun trigger by the user. Hence, while effective for quickly and efficiently covering a surface with paint, varnish, shellac, or similar liquid, the spray pattern of these devices can be difficult to control. Each parameter is independently adjustable with the result that adjusting the spray pattern is a complex, time consuming, and multi-handed procedure, entailing repeated trial and error.

Modern paints require precise control of air pressure in order to coat uniformly and hence the air pressure provided by the compressor and the consistency of same are particularly important. Accordingly, compressors generally include pressure regulators and pressure gauges so that the pressure at the junction of the compressor outlet and hose inlet may be monitored. However, because the length and diameter of the hose connecting the compressor affect the pressure actually delivered at the spray gun air inlet, the pressure reading indicated at the compressor regulator can differ significantly from that actually being delivered at the spray gun. Elaborate charts and diagrams are available which take into account variables such as the air hose length and diameter thereby allowing a user to estimate the delivery pressure. Additionally, accessory pressure gauges have been developed for installation between the air hose outlet and the inlet of the spray gun. However, the aforementioned charts are only able to provide estimates of the actual pressure being delivered and inline pressure gauges do not indicate the pressure actually being delivered at the spray gun nozzle. What is needed therefore is an indication of the air pressure actually being supplied at the spray gun nozzle.

### SUMMARY OF THE INVENTION

The present invention is an improvement with regard to pneumatic paint sprayers, in particular including those utilizing high volume low pressure air sources, and including gravity fed as well as siphon type apparatuses. The improvement includes a gas pressure gauge built into the paint sprayer in communication with the paint sprayer gas passages. The user is thereby able to monitor and control the air pressure as close to the nozzle of the paint sprayer as possible and optimizing the delivery of the material being sprayed.

It is an object of the invention to provide a spray gun having a built-in pressure gauge;

It is another object of the invention to provide a pneumatic spray gun with a pressure gauge that accurately indicates the pressure at which material is being sprayed;

It is yet another object of the invention to provide a pneumatic spray that facilitates monitoring of fluctuations in air pressure; and,

It is finally an object of the invention to provide a pneumatic spray gun that facilitates optimal delivery of the material being sprayed.

The invention will be better understood and objects other than those set forth above will become apparent when consideration is given to the following detailed description thereof. Such description makes reference to the annexed drawings wherein.

### BRIEF DESCRIPTION OF THE DRAWINGS

FIG. 1 is a perspective view of a preferred embodiment of the invention;

FIG. 2 is a perspective view of a second embodiment of the invention; and,

FIG. 3 is a cutaway view of the first preferred embodiment shown in FIG. 1.

### DETAILED DESCRIPTION OF THE INVENTION

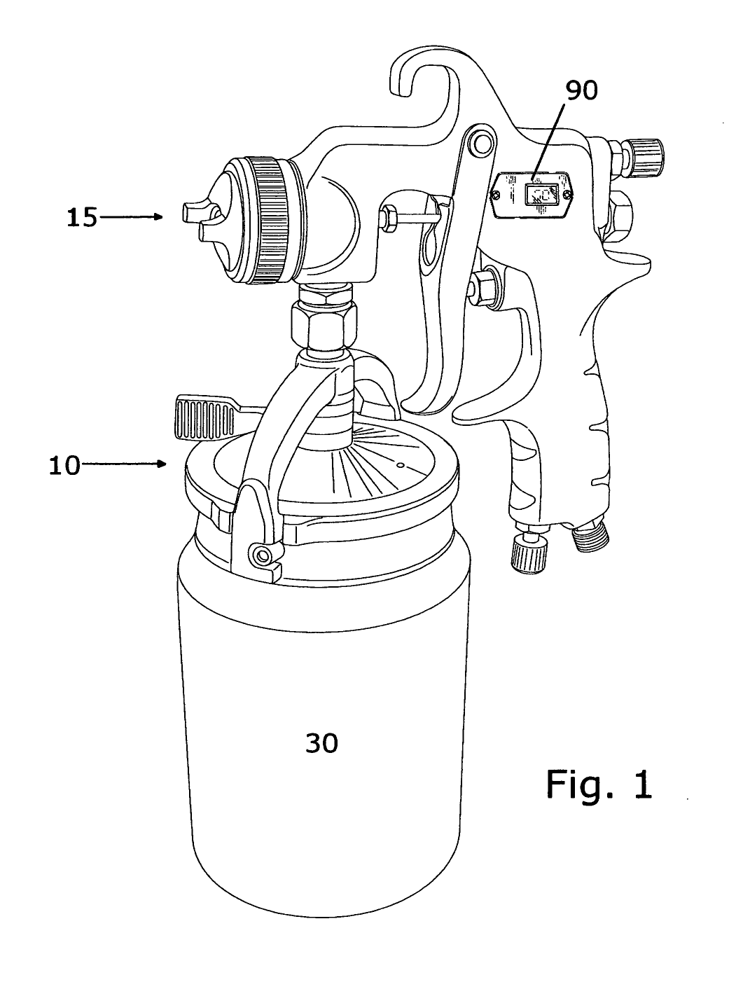

The preferred embodiments and best modes of the invention are shown in FIGS. 1 through 3. While the invention is described in connection with certain preferred embodiments, it is not intended that the present invention be so limited. On the contrary, it is intended to cover all alternatives, modifications, and equivalent arrangements as may be included within the spirit and scope of the invention as defined by the appended claims.

This invention may be constructed from any suitable material including but not limited to appropriate metals, plastics and other polymers, ceramics, and combinations thereof.

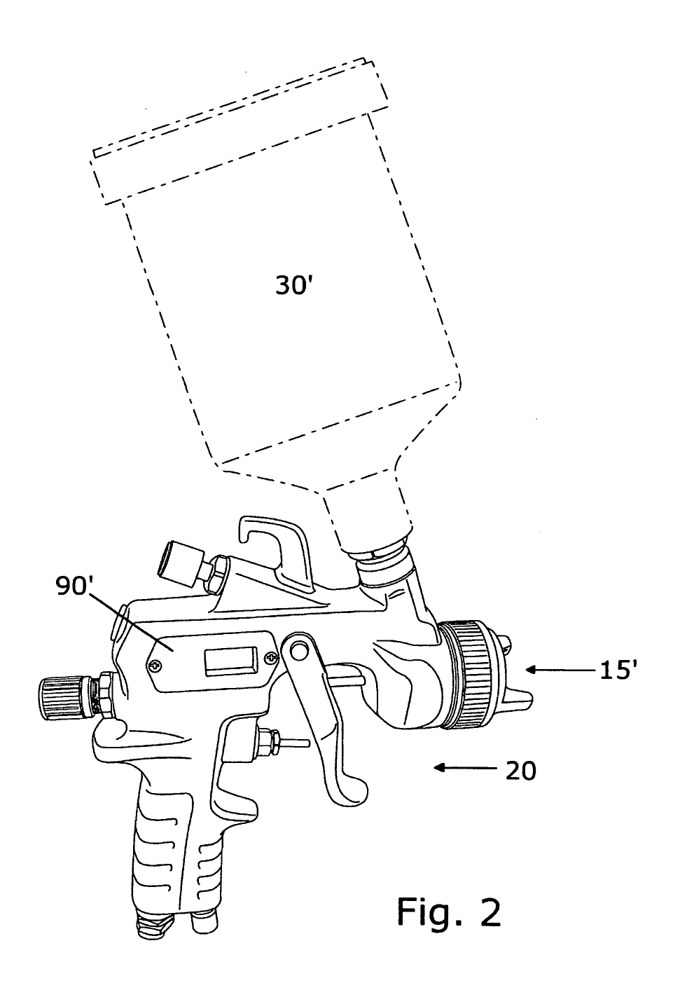

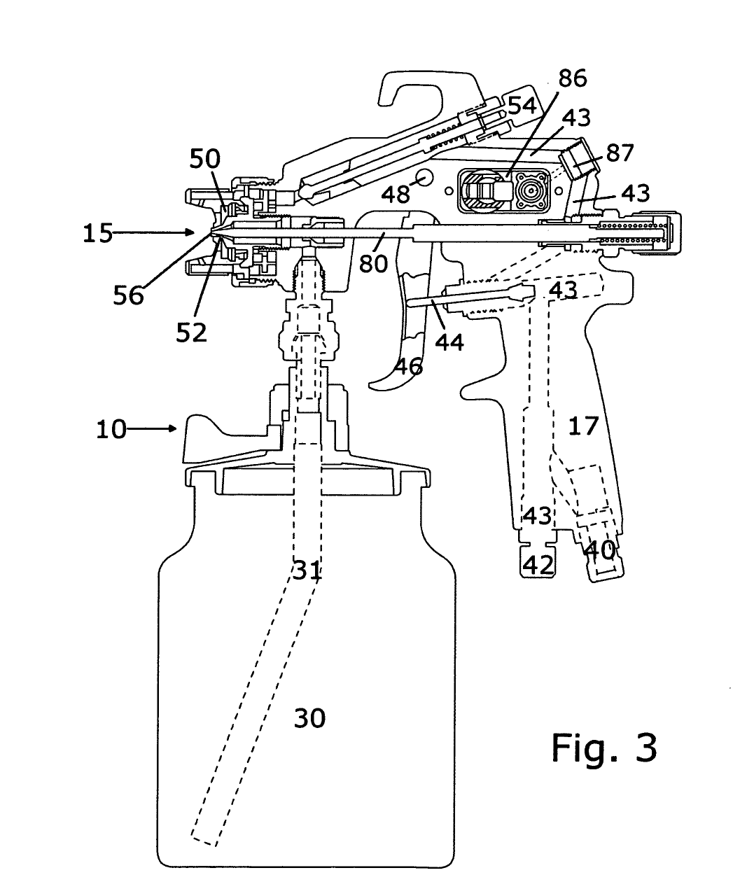

In FIGS. 1 and 2, a first preferred embodiment 10 and second preferred embodiment 20 are shown. Both function identically with regard to the present invention and differ essentially only in the mechanism by which the liquid to be sprayed is delivered to the spraying assembly 15, 15′. FIG. 1 depicts the invention 10 configured as a siphon-style spray gun, including a reservoir 30 mounted generally below the spraying assembly 15 with the liquid being sprayed is drawn into the spraying assembly 15 via a siphon tube 31 (see FIG. 3) operated via the vacuum created by operation of the spraying assembly 15. FIG. 2 depicts the invention 20 configured as a gravity-fed-style spray gun, including a hopper 30′ mounted generally above the spraying assembly 15′. Instead of the siphon mechanism used with regard to the siphon-style device 10 of FIG. 1, an aperture (not shown) in the hopper 30′ allows the to-be-sprayed material to essentially drip into the spraying assembly 15′. Absent the improvements of the present invention 10, 20, both apparatuses operate in a conventional manner understood by those skilled in the art.

As shown in FIG. 3, the apparatus of the present invention and first preferred embodiment 10 is shown in a cutaway view. Included is a reservoir 30 and siphon tube 31 used in a conventional manner to supply paint, varnish, or similar liquid to the spraying assembly 15 of the instant invention 10. The spraying assembly 15 operates in a generally conventional manner that will be understood by those skilled in the art and includes a fluid nozzle 52 in communication with the reservoir 30 and siphon tube 31. An air nozzle 50 generally surrounds the fluid nozzle 52 such that a vacuum created by air entering the nozzle and thereafter being expelled from the spray aperture 56 tends to draw liquid up from the reservoir 30 via the siphon tube 31. The liquid drawn through the siphon tube 31 subsequently mixes with and is atomized by the air from the air nozzle 50 with the result that the atomized paint, varnish, shellac, stain or similar liquid is ejected from the spray aperture 56 of the spraying assembly 15. The amount of liquid being supplied to the spraying assembly 15 is controlled by a needle valve screw assembly 80 which is screwed into the pistol grip 17.

The pistol grip 17 of the inventive apparatus 10 generally holds the assembly for introduction of the compressed air or similar gas used for operation of the apparatus 10. An air inlet 40 is formed at the base of the pistol grip 17 allowing an air supply hose (not shown) to be attached in a conventional manner, for example using ¼ inch or ⅜ inch NPT (National Pipe Thread) fittings known to those skilled in the art. Gross adjustment of air pressure is regulated by an air adjustment screw 42 in communication with the air inlet 40 via an air channel 43 defined within the pistol grip 17. Additionally, a secondary air adjustment screw 54 is provided in the upper portion of the pistol grip 17. A plunger valve 44 impinging on the air channel 43 facilitates infinitely adjustable control of the air supplied to the apparatus 10 whereby fore and all manipulation by the operator of the trigger 46 rotating about its trigger pivot 48 and bearing on the plunger valve 44 causes air to enter the spraying assembly 15 as described above with the result that atomized liquid is ejected from the spraying assembly 15.

A gas pressure gauge 86 is mounted in the upper portion of the pistol grip 17. In a preferred embodiment, the gas pressure gauge 86 is a digital gas pressure gauge 86 and includes a battery 87 in electrical communication therewith. The battery 87 is housed in a chamber defined in the spray gun housing. One skilled in the art will understand, however, that pressure gauges are well known and include force collector type sensors, for example, piezoresistive strain gauge, capacitive, electromagnetic, piezoelectric, optical, and potentiometric sensors, as well as electronic pressure sensors utilizing other phenomena, for example, resonant, thermal, ionization sensors, and the like. All are contemplated herein. The gas pressure gauge 86 is in gaseous communication with air channel 43 such that gas pressure is sampled essentially adjacent the air nozzle 50 of the spraying assembly 15. In a preferred embodiment the gas pressure gauge 86 further includes a digital display 90, 90′ (see FIGS. 1 and 2). It is contemplated, however, that any suitable display may be included, including but not limited to an analog display.

In a preferred embodiment, the gas pressure gauge 86 and digital display 90, 90′ are able to accommodate pressure readings up to and including 2 bar (approximately 29 lbs/in² (i.e., p.s.i.)). Larger and smaller maximum pressure readings are also contemplated.

In use, the proximity of the gas pressure gauge 86 of the apparatus of the present invention ensures accurate and convenient monitoring and control of the actual gas pressure at the point at which material is being ejected from a pneumatic paint and/or liquid sprayer.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

What I claim is:

1). A spray gun comprising:
liquid container means;
compressed gas introduction means;
a chamber in communication with said liquid container means and said compressed gas introduction means;
said chamber being in communication with a spray nozzle;
a trigger and trigger mediated valve controlling said compressed gas introduction means; and
gas pressure indicating means, said gas pressure indicating means being in gaseous communication with said compressed gas introduction means at a point generally adjacent said spray nozzle.

2). A spray gun as claimed in claim 1 wherein said gas pressure indicating means is a digital gas pressure indicating means.

3). A spray gun as claimed in claim 1 wherein said gas pressure indicating means indicates a maximum pressure of about 2 bar.

4). A spray gun as claimed in claim 1 wherein said gas pressure indicating means is selected from the group consisting of a piezoresistive strain gauge sensor, a capacitive sensor, an electromagnetic sensor, a piezoelectric sensor, an optical sensor, a potentiometric sensor, a resonant sensor, a thermal sensor, and an ionization sensor.

5). A spray gun as claimed in claim 1 wherein said liquid container means further comprises a siphon-type liquid reservoir means.

6). A spray gun as claimed in claim 1 wherein said liquid container means further comprises a gravity-fed-type liquid hopper means.

7). A spray gun as claimed in claim 1 wherein said spray gun is a high volume low pressure spray gun.

8). A spray gun comprising:
liquid container means;
compressed gas introduction means;
a chamber in communication with said liquid container means and said compressed gas introduction means;
said chamber being in communication with a spray nozzle;
a trigger and trigger mediated valve controlling said compressed gas introduction means; and
digital gas pressure indicating means, said digital gas pressure indicating means being in gaseous communication with said compressed gas introduction means at a point generally adjacent said spray nozzle.

9). A spray gun as claimed in claim 8 wherein said gas pressure indicating means indicates a maximum pressure of about 2 bar.

10). A spray gun as claimed in claim 8 wherein said gas pressure indicating means is selected from the group consisting of a piezoresistive strain gauge sensor, a capacitive sensor, an electromagnetic sensor, a piezoelectric sensor, an optical sensor, a potentiometric sensor, a resonant sensor, a thermal sensor, and an ionization sensor.

11). A spray gun as claimed in claim 8 wherein said liquid container means further comprises a siphon-type liquid reservoir means.

12). A spray gun as claimed in claim 8 wherein said liquid container means further comprises a gravity-fed-type liquid hopper means.

13). A spray gun as claimed in claim 8 wherein said spray gun is a high volume low pressure spray gun.

14). A spray gun comprising:
a spray gun housing;
liquid container means mounted to said spray gun housing;
high volume low pressure compressed gas introduction means formed in said housing;
a chamber in said spray gun housing in communication with said liquid container means and said compressed gas introduction means;
said chamber being in communication with a spray nozzle;
a trigger and trigger mediated valve controlling said compressed gas introduction means; and
a digital gas pressure indicating gauge in gaseous communication with said compressed gas introduction means at a point adjacent said spray nozzle.

15). A spray gun as claimed in claim 14 wherein said gas pressure indicating gauge indicates a maximum pressure of about 2 bar.

16). A spray gun as claimed in claim 14 wherein said liquid container means is a siphon-type liquid reservoir means.

17). A spray gun as claimed in claim 14 wherein said liquid container means is a gravity-fed-type liquid hopper means.

18). A spray gun as claimed in claim 14 wherein a battery to power said digital gas pressure measuring gauge is mounted in said housing and is electrically connected to said digital gas pressure measuring gauge.
